(19) United States
(12) Patent Application Publication
(10) Pub. No.: US 2024/0372199 A1
(43) Pub. Date: Nov. 7, 2024

(54) Battery Module

(71) Applicant: Mercedes-Benz Group AG, Stuttgart (DE)

(72) Inventor: Markus FRANKENHAUSER, Ehingen (Donau) (DE)

(21) Appl. No.: 18/561,093

(22) PCT Filed: Dec. 8, 2022
(86) PCT No.: PCT/EP2022/085041

§ 371 Date: Nov. 15, 2023

(30) Foreign Application Priority Data
Dec. 16, 2021 (DE) 10 2021 006 208.6

(51) Int. Cl. H01M 50/244; H01M 10/613; H01M 10/6554; H01M 50/213

(52) U.S. Cl. CPC H01M 50/244; H01M 10/613; H01M 10/6554; H01M 50/213

(57) ABSTRACT

A battery module includes a module housing which has a receiving opening. A battery cell is disposed in the receiving opening and a region that is flowable through by a cooling medium is disposed adjacent to the receiving opening. A plate is disposed on a side of the module housing where the plate has an aperture that corresponds to a dimension of the battery cell. The receiving opening has, at least in a section, a greater cross-section than the aperture. The battery cell has a stop where the stop is contactable with a tapered portion of the receiving opening and/or with the plate.

### BACKGROUND AND SUMMARY OF THE INVENTION

The invention relates to a battery module having a module housing, which has receiving openings for individual battery cells, according to the type defined in greater detail herein.

Battery modules having a module housing for accommodating individual battery cells are known from the prior art. A battery can thus be gleaned, for example, from DE 102 23 782 B4, which consists substantially of a battery housing or module housing in which receiving openings are introduced between two opposite sides. Individual battery cells—in this instance cylindrical individual battery cells—are pushed into these receiving openings. They are appropriately cooled in the module housing, which is also referred to as jacket cooling.

To that effect, a structure is known from CN 108 281 588 A, in which the individual cells stand on a cooling plate without support and are cooled by this cooling plate. The problem with these kinds of structures is that the cooling takes place on only one side in the region of each of the individual battery cells, such that relatively inhomogeneous cooling occurs. If the individual battery cell is now charged, in particular fast-charged, then this leads to relatively high levels of heat loss in the individual battery cell during a fast charge of this type. If these are not discharged evenly and homogeneously, this can contribute to premature ageing of the cell and have a negative influence on its capacity.

Finally, DE 10 2016 219 302 A1 moreover describes a battery in which the individual battery cells are contacted and held via a plate, wherein these individual battery cells can then have a cooling medium flowing around them in a free space underneath the plate.

In all these structures, it is the case that, during assembly, the arrangement of the batteries in terms of their height relative to the plates is difficult to maintain, such that either high tolerances have to be accepted here or a large amount of effort has to be expended to avoid such tolerances. In practice, tolerances in this region are often to be classified as critical, since the underlying dimensions are required, for example, in a vehicle structure for compensation zones or as discharge channels for gases escaping in the event of cell failure, and require a defined minimum cross-section.

The object of the present invention now consists in specifying an improved battery module having a module housing and individual battery cells, which on the one hand guarantees highly uniform cooling of the individual battery cells and on the other hand creates the possibility for simple and efficient assembly.

In the battery module according to the invention, it is correspondingly provided that the module housing has receiving openings for the individual battery cells between two opposite sides, wherein regions are arranged around these receiving openings in the module housing, which are to have a cooling medium flow through them, such that jacket cooling of the individual battery cells can therefore take place at least in sections. According to the invention, it is now the case that a plate is arranged on one side of the module housing, which can form, for example, a base plate. This has apertures that correspond to the dimensions of the individual battery cells, wherein, in contrast to these, the receiving openings have, at least in sections, a greater cross-section than the apertures, such that the individual battery cells can be inserted into these receiving openings more easily. The individual battery cells themselves have stops for contact with a tapered portion of the receiving opening and/or with the plate. They can be inserted extraordinarily simply and efficiently into the respective receiving opening and are pushed through the receiving opening and the aperture in the plate, for example a base plate, until the stop comes into contact with the pre-determined region. An exact positioning of the individual battery cells relative to the module housing or the plate is thus always provided without complex measures. If the plate is designed, for example, as a base plate, the individual battery cells protrude through the apertures in the plate around a part that can be pre-determined by the stops, such that the cross-sections in space located underneath the plate can be easily and precisely adhered to in the desired manner.

According to a highly advantageous development of the battery module according to the invention, the stops are formed by a self-adhesive material. They can, in particular during the production of the individual battery cells, be adhered directly to the exterior of the individual battery cells, such that they can be inserted into the module housing up to these adhered stops. A highly advantageous development of this provides that the stops are designed in the form of an adhesive tape, in particular in the form of a foam adhesive tape.

In an alternative design of the electrical energy store, the stops on the individual battery cells can be dispensed with, wherein precise positioning relative to the housing or the base plate for jacket cooling can be achieved by the individual battery cells being supported by a height-adjustable carrier plate underneath the plate, which in this instance serves as a stop. After fixing the individual battery cells with an adhesive or thermally conductive adhesive in the cooling/holding device, the carrier plate can be removed again.

The plate itself can, according to a highly advantageous development of the battery module according to the invention, be designed as a cooled plate, in particular a cooled base plate. Such a cooled plate, which is in principle also known from previous structures of batteries or battery modules, can also be used here. In addition to jacket cooling, end plate cooling can also be implemented to ensure even more consistent temperature control of the individual battery cells. This significantly increases the fast-charging capability of such a battery module.

The receiving openings themselves can, according to a highly advantageous development of the battery module, be designed according to the invention in such a way that they taper conically in the direction of the plate. This enables a particularly simple and efficient insertion of the individual battery cells into the receiving openings. Alternatively, these may also have a consistent cross-section, which is then so much larger over its entire height than the corresponding aperture that the stops, which then preferably abut on the plate, fit into the region of the receiving opening.

The individual battery cells can be fixed to the receiving opening by a thermally conductive adhesive, independently of whether it tapers conically or is formed with a consistent cross-section. On the one hand, this thermally conductive adhesive reliably secures the individual battery cells in position and, on the other hand, owing to its heat-conducting properties, allows jacket cooling of the individual battery cells via the regions in the module housing that have cooling medium flowing through them.

A further extraordinarily favourable design of the battery module according to the invention can furthermore provide that the individual battery cells are cast with a casting compound on the side of the module housing facing away from the plate. Such casting compounds are generally conventional in the field of electronics and ensure, on the one hand, secure fixing and, on the other, electrical insulation of the structure. The casting compound can, for example, be sealed off by a battery cover and cast directly with it. Electronics can moreover be arranged and cast in the region of the casting compound.

A further extraordinarily favourable design of the battery module according to the invention provides, during the use of the casting compound, that it has, or consists of, a latent heat accumulator material. The casting compound then forms a latent heat accumulator, so can absorb heat relatively well up to a certain temperature and can hold it in for a relatively long period of time. This ensures a further improvement in cooling and therefore in temperature homogenization, in particular when the individual battery cell heats up considerably, as is the case during a fast-charging process, for example. By improving the temperature homogenization, i.e., improving the temperature distribution within the individual battery cells, a relatively high level of charging power is possible, which helps to reduce the time it takes to fully charge the battery significantly.

In principle, the structure of the battery module according to the invention is suitable for any type of individual battery cell in one or more of the described embodiments. The individual battery cells can therefore be, for example, prismatic individual battery cells in a film bag, so-called pouch cells, or even prismatic individual battery cells in a hard case. However, it is preferably provided that the individual battery cells in the battery module according to the invention have, according to a highly advantageous development thereof, a cylindrical shape. Such cylindrical cells can be simply and efficiently positioned in such a battery module. Both the receiving openings and the apertures having a cylindrical and/or conical shape can be produced correspondingly simply in order to implement a highly cost-effective structure of the battery module. The module housing itself can be produced in particular as an injection-moulded part made from a plastic material, which can have increased thermal conductivity due to appropriate additives. The plate or base plate can preferably be produced from a metallic material.

Further advantageous designs of the battery module according to the invention also arise from the two exemplary embodiments, which are illustrated in greater detail below with reference to the figures.

### BRIEF DESCRIPTION OF THE DRAWINGS

FIG. 1 shows a schematic cross-section through a section from the battery module according to the invention; and

FIG. 2 is a view that is analogous to the one in FIG. 1, in an alternative embodiment.

### DETAILED DESCRIPTION OF THE DRAWINGS

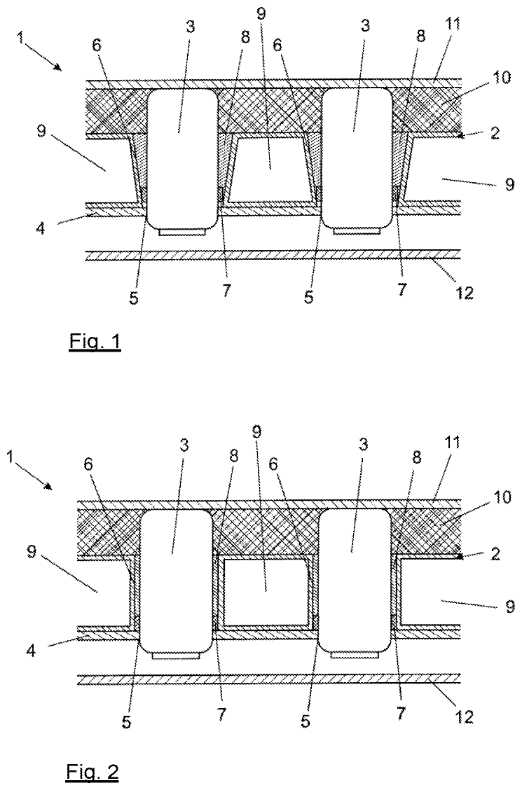

The section of a battery module 1 depicted in FIG. 1 shows a module housing 2 in which two individual battery cells 3 are correspondingly installed. The module housing 2 has, on its lower side here, a plate or base plate designated as 4, which accommodates apertures 5 that correspond to the shape of the individual battery cells 3. Receiving openings 6 of the module housing 2 are located above this. These receiving openings 6 have a larger cross-section, or in the case of cylindrical individual battery cells 3, a larger diameter, than the apertures 5. In the exemplary embodiment in FIG. 1, they taper conically, such that their cross-section progressively decreases in the direction of the plate 5.

The individual battery cells 3 are provided with a stop 7 in the form of a foam adhesive tape that serves as a stop 7, such that the individual battery cells can only be inserted into the receiving openings 6, which are conical here, up to a pre-determined depth. The position of the individual battery cells 3 within the module housing 2, and thus ultimately within the battery module 1 with respect to their installation height, is therefore firmly pre-determined by these stops 7. In the depiction in FIG. 1, a cavity is located underneath the individual battery cells 3, the cavity serving to discharge venting gases if one or more of the individual battery cells 3 undergoes thermal runaway and blows off gases. Due to the defined installation height of the individual battery cells 3 above the stops 7, the cross-section that can be flowed through in this space can always be reliably guaranteed.

During insertion of the individual battery cells 3 into the receiving opening 5, they are adhered to the module housing 2 using a thermally conductive adhesive 8. It is hereby possible to cool them down via regions 9 that can have a cooling medium flowing through in the module housing in the region of their jacket. This jacket cooling, in addition to cooling via the base plate 4, enables very homogeneous temperature control of the individual battery cells 3, even with high heat input, such as occurs during fast charging, for example.

In the exemplary embodiment depicted here, a casting compound 10 represented with irregular cross-hatching is located above the module housing 2. The ends of the battery are cast over this before a cover plate 11 is applied. The casting compound 10 itself can be designed as a latent heat accumulator or can have a latent heat accumulator material. It then additionally serves for homogeneous temperature control of the battery module 1. The previously discussed cavity underneath the plate 4 is sealed off by a further plate-shaped cover, which can be, for example, the underside of a housing of the battery module 1. The plate-shaped cover 12 could, at the same time, also be an underride guard for a vehicle, if the battery is used in the floor area of a vehicle.

This highly efficient structure of the battery module 1 can now be varied further. In the depiction in FIG. 2, an alternative embodiment can be recognized, in which the receiving openings 6 no longer taper conically, but rather are also designed to be cylindrical, for example if the individual battery cells 3 are cylindrical. The stops 7 then no longer come into contact at a defined point of the receiving openings 6 on the module housing 2, but rather directly on the base plate 4. Otherwise, the gap between the module housing 2 and the individual battery cells 3 in the region of the receiving openings 6 is also filled with the thermally conductive adhesive 8 and the structure is sealed off by a casting compound 10 that is preferably designed here as a latent heat accumulator.

Otherwise, the same as has already been explained in the context of the embodiment according to FIG. 1 applies for the embodiment according to FIG. 2. The same components also have the same reference numerals.

1.-10. (canceled)

11. A battery module (1), comprising:
a module housing (2) which has a receiving opening (6);
a battery cell (3) disposed in the receiving opening (6), wherein a region (9) that is flowable through by a cooling medium is disposed adjacent to the receiving opening (6); and
a plate (4) disposed on a side of the module housing (2), wherein the plate (4) has an aperture (5) that corresponds to a dimension of the battery cell (3);
wherein the receiving opening (6) has, at least in a section, a greater cross-section than the aperture (5);
wherein the battery cell (3) has a stop (7), wherein the stop (7) is contactable with a tapered portion of the receiving opening (6) and/or with the plate (4).

12. The battery module (1) according to claim 11, wherein the stop (7) is a self-adhesive material.

13. The battery module (1) according to claim 12, wherein the self-adhesive material is a foam adhesive tape.

14. The battery module (1) according to claim 11, wherein the plate (4) is a cooled base plate (4).

15. The battery module (1) according to claim 11, wherein the receiving opening (6) tapers conically in a direction of the plate (4).

16. The battery module (1) according to claim 11, wherein the receiving opening (6) has a consistent cross-section.

17. The battery module (1) according to claim 11, wherein the battery cell (3) is fixed into the receiving opening (6) by a thermally conductive adhesive (8).

18. The battery module (1) according to claim 11, wherein the battery cell (3) is cast with a casting compound (10) on a side of the module housing (2) facing away from the plate (4).

19. The battery module (1) according to claim 18, wherein the casting compound (10) has a latent heat accumulator material or consists of the latent heat accumulator material.

20. The battery module (1) according to claim 11, wherein the battery cell (3) has a cylindrical shape.
